(19) United States
(12) Patent Application Publication
(10) Pub. No.: US 2025/0125958 A1
(43) Pub. Date: Apr. 17, 2025

(54) SYSTEMS AND METHODS OF MANAGING ORIGIN KEYS FOR CRYPTOGRAPHIC AUTHENTICATION

(71) Applicant: Capital One Services, LLC, McLean, VA (US)

(72) Inventors: Kevin OSBORN, Newton Highlands, MA (US); Srinivasa CHIGURUPATI, Long Grove, IL (US)

(73) Assignee: Capital One Services, LLC, McLean, VA (US)

(21) Appl. No.: 18/915,790

(22) Filed: Oct. 15, 2024

Related U.S. Application Data
(60) Provisional application No. 63/544,314, filed on Oct. 16, 2023.

(51) Int. Cl. H04L 9/32; H04L 9/06; H04L 9/08

(52) U.S. Cl. CPC H04L 9/32; H04L 9/0625; H04L 9/0631; H04L 9/0825; H04L 9/085

(57) ABSTRACT

A method for managing origin keys for cryptographic authentication is provided. The method includes creating, by a server, at least one super origin key and diversifying, by the server, the at least one super origin key into at least one origin key. The method further includes generating, by the server, a plurality of secret sharing portions of the at least one origin key, dividing, by the server, the plurality of secret sharing portions into multiple parts, encrypting, by the server, the multiple parts of the plurality of secret sharing portions, and transmitting, by the server, the encrypted multiple parts of the plurality of secret sharing portions to multiple entities.

### CROSS-REFERENCE TO RELATED APPLICATION

This application claims the priority of U.S. Provisional Patent Application No. 63/544,314, filed Oct. 16, 2023, the contents of which are incorporated herein by reference in their entirety.

### FIELD OF THE INVENTION

The present disclosure relates generally to card technology, and more particularly, to systems and methods for managing origin keys for cryptographic authentication.

### BACKGROUND

In the payment card industry, identity verification can be externalized and handled by third parties. For example, one entity issuing a payment card might route authentication requests to a verifier for verifying the payment card, and the verifier might be different from a card manufacturer of the payment card.

In order to verify a card, the card manufacturer needs origin keys. The card manufacturer also requires the creation of unique derived keys (UDKs) for card personalization. In conventional methods of card verification, origin keys are not copied to a memory or across a network, except for exporting the UDKs for personalization.

If origin keys can be exported, it would be useful if they were never stored, except for the initial sharing with the card manufacturer for personalization and the verifier for verifying the payment card. Also, if operations of the entity issuing the payment card are disrupted or unable to continue, it would be useful to recover the origin keys for that entity knowing only that entity's identification.

Accordingly, there is a need to provide systems and methods for managing origin keys for cryptographic authentication of payment cards.

### SUMMARY

Aspects of the disclosed technology include systems and methods of managing origin keys for cryptographic authentication.

Embodiments of the present disclosure provide a method for managing origin keys for cryptographic authentication. The method comprises: creating, by a server, at least one super origin key; diversifying, by the server, the at least one super origin key into at least one origin key; generating, by the server, a plurality of secret sharing portions of the at least one origin key; dividing, by the server, the plurality of secret sharing portions into multiple parts; encrypting, by the server, the multiple parts of the plurality of secret sharing portions; and transmitting, by the server, the encrypted multiple parts of the plurality of secret sharing portions to multiple entities.

Embodiments of the present disclosure provide a system for managing origin keys for cryptographic authentication. The system comprises a server. The server is configured to: create at least one super origin key; diversify the at least one super origin key into at least one origin key; generate a plurality of secret sharing portions of the at least one origin key; divide the plurality of secret sharing portions into multiple parts; encrypt the multiple parts of the plurality of secret sharing portions; and transmit the encrypted multiple parts of the plurality of secret sharing portions to multiple entities.

Embodiments of the present disclosure provide a non-transitory, computer-readable medium comprising instructions for managing origin keys for cryptographic authentication that, when executed on a computer arrangement, perform actions comprising: creating at least one super origin key; diversifying the at least one super origin key into at least one origin key; generating a plurality of secret sharing portions of the at least one origin key; dividing the plurality of secret sharing portions into multiple parts; encrypting the multiple parts of the plurality of secret sharing portions; and transmitting the encrypted multiple parts of the plurality of secret sharing portions to multiple entities.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 illustrates a system for managing origin keys for cryptographic authentication according to an example embodiment.

FIG. 2 illustrates an example diagram of sequence interactions between the components of FIG. 1 according to an example embodiment.

FIG. 3 illustrates a contactless card according to an example embodiment.

FIG. 4 is a diagram of components of the contactless card in FIG. 3 according to an example embodiment.

FIG. 5 illustrates a flow chart of an example method for managing origin keys for cryptographic authentication of a contactless card according to an example embodiment.

FIG. 6 illustrates a flow diagram of diversifying keys using different derivation algorithms according to an example embodiment.

### DETAILED DESCRIPTION OF EXAMPLE EMBODIMENTS

T The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

As described above, contactless card identity verification may be externalized and handled by third parties. In an example embodiment of the present disclosure, a contactless card may use two origin keys (one encryption origin key and one authentication origin key) which are used to diversify using a unique identification (ID) number (pUID) of the contactless card into two UDKs (one encryption UDK and one authentication UDK). The two UDKs are personalized on the contactless card and further used in every transaction to create two session keys (one encryption session key and one authentication session key). In conventional use cases, the two origin keys are never copied to a memory other than a hardware security module (HSM) or transmitted across a network, except for exporting the two UDKs for personalization.

In the present disclosure, however, origin keys can be exported, but it would be useful if they were never stored, except for the initial sharing with the card manufacturer for personalization and the verifier for verifying the payment card. Also if operations of the entity issuing the payment card are disrupted or unable to continue, it would be useful to recover the origin keys for that entity knowing only that entity's identification.

In the present disclosure, the entity, such as a bank, can be assigned a vendor and/or population ID. Two super origin keys can be created. The two super origin keys can be diversified into two origin keys (also referred to as “population” origin keys) associated with the vendor ID of the entity. That is, the two origin keys can be generated by combining the two super origin keys and the vendor ID of the entity. Shannon secret sharing portions of the two origin keys can then be divided and encrypted and delivered to the entity, the card manufacturer and the verifier using multiple secure channels.

If the card manufacturer and/or the verifier are expected to not continue its operations for, e.g., the duration of a contractual arrangement and/or indefinitely, one or more parts of a plurality of parts of secret sharing for installing the origin keys can be held back by that entity and insist on being present for the card manufacturer and/or the verifier to install the origin keys. If the origin keys are ever lost, they can be regenerated with the vendor ID and super origin keys. Accordingly, the present disclosure can reduce the burden to two super original keys for an infinite number of participants in the ecosystem. The present disclosure can allow for securely recovering origin keys and recreating origin keys. For example, if a particular card issuer or a particular card manufacturer goes out of business, the origin keys associated with the particular card issuer or the particular card manufacturer can be recreated for a new player in this space.

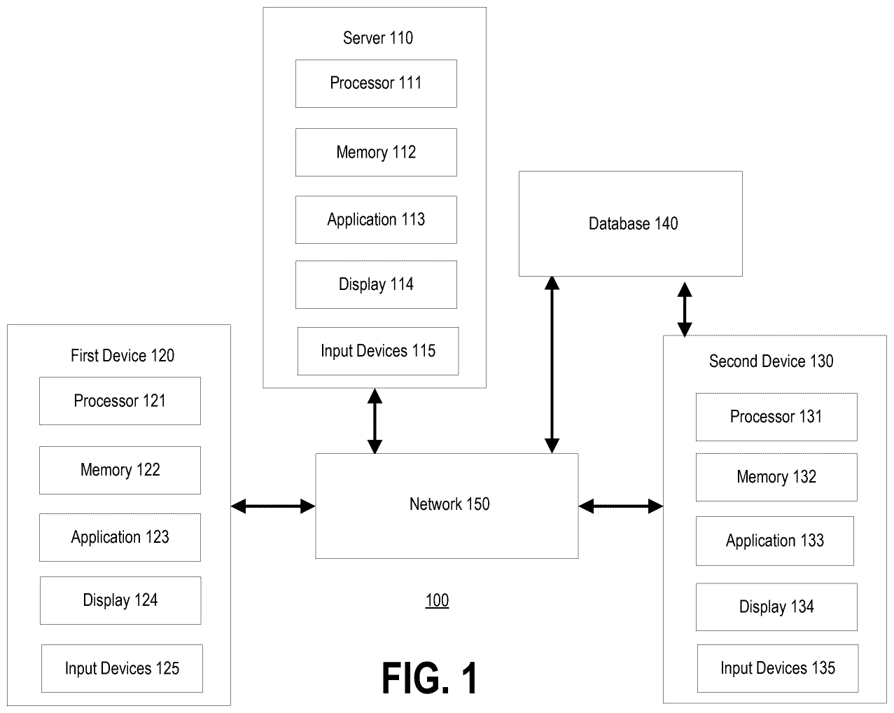

FIG. 1 illustrates a system 100 for managing origin keys for cryptographic authentication according to an example embodiment. As further discussed below, the system 100 may include a server 110, a first device 120, a second device 130, and a database 140 in communication using a network 150. Although FIG. 1 illustrates single instances of the components, the system 100 may include any number of components.

The server 110 may be associated with a bank or an entity managing super origin keys and (population/vendor) origin keys. The server 110 can be configured to store customer information, and to present an interaction interface on which a customer can conduct interactions with the brank or entity.

The server 110 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, or another computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 110 may include a processor 111, a memory 112, and an application 113. The processor 111 may be a processor, a microprocessor, or other processor, and the server 110 may include one or more of these processors. The processor 111 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the server 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the server 110. In some examples, the server 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions described herein. For example, the application 113 may be executed to perform generating super origin keys and diversifying the super origin keys into origin keys based on vendor IDs. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the server 110 that is available and supported by the server 110, such as a touch-screen, keyboard, mouse, cursor-control device, touch-screen, microphone, digital camera, video recorder or camcorder. These devices may be used to enter information and interact with the software and other devices described herein.

The first device 120 can be used by a bank or contactless card manufacturer and/or issuer to initiate and/or perform transactions/interactions with the server 110. The first device 120 may be configured to present a user interface from which a user may log into, for example, their bank or credit card account to access their transaction statement and/or financial information. The first device 120 may be configured to receive origin keys diversified from the super origin keys based on a vendor ID of the first device 120.

The first device 120 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, or another computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 120 may include a processor 121, a memory 122, an application 123, a display 124, and input devices 125. The processor 121 may be a processor, a microprocessor, or other processor, and the first device 120 may include one or more of these processors. The processor 121 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the first device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as origin keys, private and personal information.

The application 123 may comprise one or more software applications comprising instructions for execution on the first device 120. In some examples, the first device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions described herein. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system.

The first device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the first device 120 that is available and supported by the first device 120, such as a touch-screen, keyboard, mouse, cursor-control device, touch-screen, microphone, digital camera, video recorder or camcorder. These devices may be used to enter information and interact with the software and other devices described herein such as selecting an option of creating an online account with the branch.

The second device 130 may be associated with a contactless card validator or a bank and can be configured to communicate with the server 110 and the first device 120. The second device 130 may be configured to authenticate the contactless card based on the origin keys.

The second device 130 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, or another computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 130 may include a processor 131, a memory 132, and an application 133. The processor 131 may be a processor, a microprocessor, or other processor, and the second device 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the second device 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the second device 130. In some examples, the second device 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions described herein. For example, the card authentication module of the application 133 may be executed to perform authenticating a user based on the contactless card. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The second device 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the second device 130 that is available and supported by the second device 130, such as a touch-screen, keyboard, mouse, cursor-control device, touch-screen, microphone, digital camera, video recorder or camcorder. These devices may be used to enter information and interact with the software and other devices described herein.

The database 140 may be one or more databases configured to store date, including without limitation, super origin keys, vendor IDs, private information of users, financial accounts of users, and contactless card information. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 110 or may be hosted externally of the server 110, such as by a server, by a cloud-based platform, or in any storage device that is in data communication with the server 110.

The system 100 may include one or more networks 150. In some examples, the network 150 may be one or more of a wireless network, a wired network or any combination of wireless network and wired network, and may be configured to connect the server 110, the first device 120, the second device 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the server 110, first device 120, and second device 130 using the network 150 can occur using one or more front channels and one or more secure back channels. A front channel may be a communication protocol that employs a publicly accessible and/or unsecured communication channel such that a communication sent to the server 110, first device 120, and/or second device 130 may originate from any other device, whether known or unknown to the server 110, first device 120, and/or second device 130, if that device possesses the address (e.g., network address, Internet Protocol (IP) address) of the server 110, first device 120, and/or second device 130. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the server 110, first device 120, and/or second device 130 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

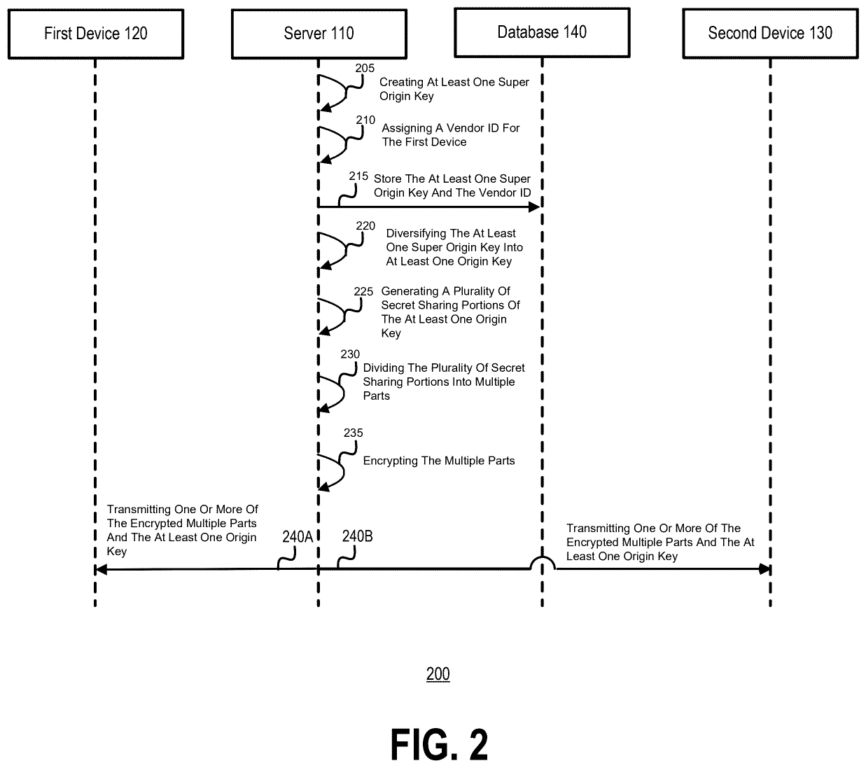

FIG. 2 illustrates an example diagram 200 of sequence interactions between the components of the system 100 according to an example embodiment. FIG. 2 may reference the same or similar components as those illustrated in FIG. 1, including a first device, a second device, a server, and a database.

In step 205, the server 110 creates at least one super origin key, for example two super origin keys. One super origin key can be an encryption super origin key, and the other one can be an authentication super origin key.

When the server 110 receives from the first device 120 a request of participating in a network of using a contactless card, in step 210, the server 110 can generate and assign a vendor ID for an entity associated with the first device 120. For example, the entity may be an financial institute different from an entity associated with the server 110. The entity associated with the server 110 may be an entity managing the network of using contactless cards.

In step 215, the server 110 may store the at least one super origin key and the vendor ID onto the database 140. The server 110 may also store the at least one super origin key and the vendor ID in one of its memories for quick searching.

In step 220, the server 110 may diversify the at least one super origin key into at least one origin key. For example, the server 1110 may diversify the two super origin keys into two corresponding origin keys. One can be an encryption origin key and the other can be an authentication origin key. The server 110 may diversify the two super origin keys into two corresponding origin keys, based on the vendor ID of the first device 120, so the two corresponding origin keys can be associated with the entity of the first device 120. In cases where the two origin keys are lost, damaged, and/needed to be recreated, the two origin keys can be regenerated specifically for the entity of the first device 120 by using the two super origin keys and the vendor ID.

In step 225, the server 110 may generate a plurality of secret sharing portions of the at least one origin key. For example, the server may generate a plurality of Shannon secret sharing portions of the two origin keys.

In step 230, the server 110 may divide the plurality of secret sharing portions into multiple parts. In step 235, the server 110 may encrypt the multiple parts.

In steps 240A and 240B, the server 110 may transmit one or more of the encrypted multiple parts and the at least one origin key to the first device 120 and the second device 130, respectively. In some examples, of the total number of encrypted multiple parts (referred to in examples herein as “N total parts”), the server 110 may transmit a certain number (referred to in examples herein as “X parts”) of the encrypted multiple parts and the two origin keys to the first device 120, and the server 110 may transmit another certain number (referred to in examples herein as “Y parts”) of the encrypted multiple parts and the two origin keys to the second device 130, where the number of the encrypted multiple parts transmitted to the first device 120 (e.g., X parts) plus the number of the encrypted multiple parts transmitted to the second device 130 (e.g., Y parts) can be less than or equal to the total encrypted multiple parts (e.g., the N total parts).

As described herein, the entity of the first device 120 may be a bank that issues a contactless card managed by the entity associated with the server 110, and the entity associated with the second device 130 may be validator or verifier of the contactless card. The entity of the first device 120 may contract the entity associated with the second device 130 for validating the contactless card. The first device 120 may customize the contactless card by diversifying the two origin keys into two unique derived keys (UDKs). One of the UDKs can be an encryption key and the other one can be an authentication key. The two UDKs would be stored in the contactless card for personalization which can be unique to that contactless card. When a transaction such as a purchase can be conducted using the contactless card, the two UDKs stored on the contactless card would be used by the contactless card to generate two session keys (one for encryption and the other for authentication) for creating a cryptogram for validating and/or authorizing the transaction by the second device 130.

The second device 130 may be able to access the two origin keys only when the second device 130 has the parts transmitted to the first device 120 (e.g., the X parts) plus the parts transmitted to the second device 130 (e.g., the Y parts) of the encrypted multiple parts of the plurality of secret sharing portions. That is, even though the second device 130 has received from the server 110 the parts transmitted to the second device 130 (e.g., the Y parts) of the encrypted multiple parts and the two origin keys, the second device 130 cannot access the two origin keys by having only the Y parts of the encrypted multiple parts. The second device 130 may request the additional X parts of the encrypted multiple parts from the first device 120 and then can be allowed to access the two origin keys.

A contactless card used herein may be any type of card, such as a security card, a payment card, an identification card, a transportation card, a point of access card, and the like. For example, the contactless card may be issued to a user by a financial institution for identity verification for a bank account of the user, such as by the entity associated with the first device 120 and may be validated by the entity associated with the second device 130.

In some examples, the contactless card may be manufactured by third entity different from both the entity associated with the first device 120 and the entity associated with the second device 130. In such embodiments, the two origin keys and a certain number of the encrypted multiple parts (referred to in examples herein as “Z parts”) of the plurality of sharing secret portions can also be transmitted by the server 110 to the third entity through a device associated with the third entity. As for the second device 130, the third entity's device may be able to access the two origin keys only when the third entity's device has the requisite number of the encrypted multiple parts (e.g., the X parts plus the Y parts, plus the Z parts) of the plurality of secret sharing portions. That is, even though the third entity's device has received from the server 110 a certain number of parts of the encrypted multiple parts (e.g., the Z parts) and the two origin keys, the third entity's device cannot access the two origin keys by having less than the requisite number of parts of the encrypted multiple parts (e.g., only the Z parts). The third entity's device may request the additional parts of the encrypted multiple parts (e.g., the X parts from the first device 120 and the Y parts from the second device 130) and can be of obtained, would be allowed to access the two origin keys. The third entity's device can then diversify the two origin keys into two unique derived keys (UDKs). In some other embodiments, in order to access the two origin keys, the third entity's device may be required to have only the Z parts plus the X parts from the first device 120 or only the Z parts plus the Y parts from the second device 130. That is, the third entity's device may not be required to have all the X, Y and Z parts to access the two origin keys.

In some examples, one of the UDKs can be an encryption key and the other one can be an authentication key, and once the UDKs are created, they are stored on the contactless card to personalize the contactless card. The contactless card can be configured to transmit a cryptogram to a user device upon tapping to the user device. The user device may be configured to read the cryptogram from the contactless card after entry of the contactless card into a communication field of the user device. The user device may then transmit the cryptogram to the second device 130. The second device 130 may be configured to verify the cryptogram.

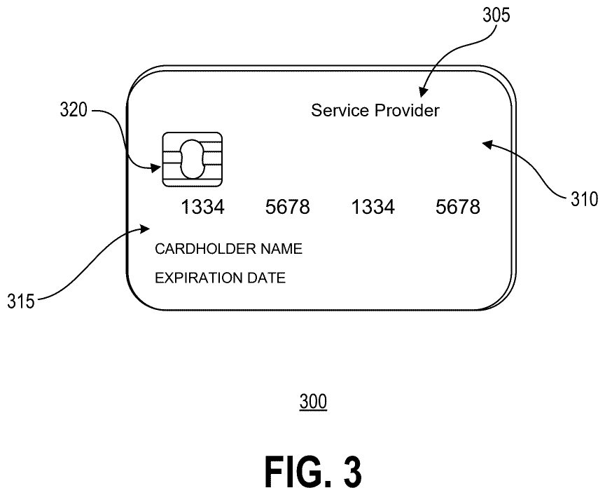

FIG. 3 describes a contactless card 300 that can be used in the system 100 of FIG. 1. The contactless card 300 may comprise a payment card, such as a credit card, debit card, or gift card, issued by the entity associated with the first device 120 (such as a bank) displayed on the front or back of the contactless card 300. In some examples, the contactless card 300 is not related to a payment card, and may comprise, without limitation, an identification card, a membership card, a transportation card, and a point of access card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, or tablet computer. The contactless card 300 may also include processing circuitry, antenna and other components. These components may be located behind the contact pad 320 or elsewhere on the substrate. The contactless card 300 may also include a magnetic strip or tape, which may be located on the back of the contactless card 300.

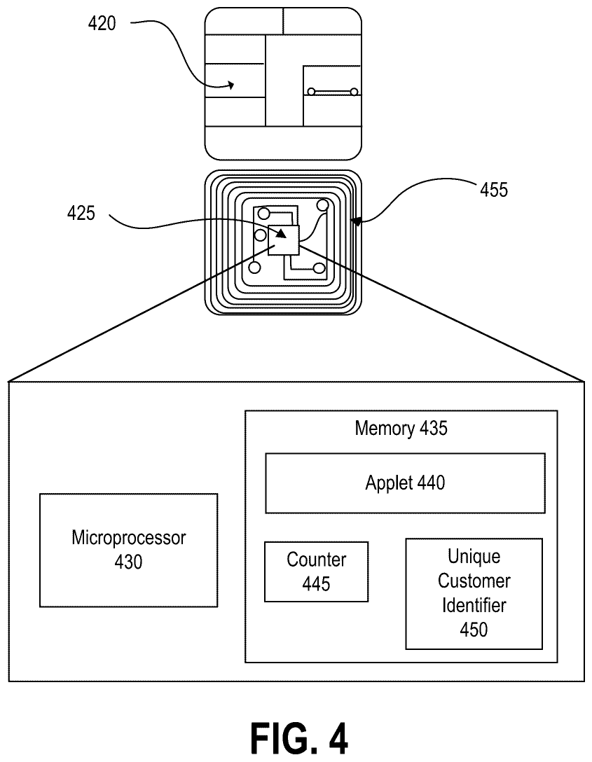

FIG. 4 illustrates example components of a contactless card. The contact pad 420 of the contactless card may include processing circuitry 425 for storing and processing information, including a processor 430 and a memory 435. It is understood that the processing circuitry 425 may contain additional components, including processors, memories, error and parity and/or CRC checkers, data encoders, anticollision algorithms, controllers, command decoders, security primitives and tamperproofing hardware, as necessary to perform the functions described herein.

The memory 435 may be a read-only memory, write-once read-multiple memory or read/write memory, e.g., RAM, ROM, and EEPROM, and the contactless card may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some examples, the memory 435 may also have stored public and private card encryption keys. In some examples, the private and public encryption keys may be permanently hard-wired into the card memory 435. In various embodiments, the memory 435 may have stored therein instructions for generating encrypted information and transmitting it to a receiving device. Such encrypted information may be or include an encrypted verification block or signature that may be used to authenticate and verify the presence of the contactless card during transaction processing. In some examples, encrypted information may be unique to a particular communication (e.g., a particular NFC transmission by the contactless card).

The memory 435 may be configured to store one or more applets 440, one or more counters 445, and a unique customer identifier 450. The one or more applets 440 may comprise one or more software applications configured to execute on one or more contactless cards, such as Java Card applet. However, it is understood that the one or more applets 440 are not limited to Java Card applets, and instead may be any software application operable on contactless cards or other devices having limited memory. The one or more counters 445 may comprise a numeric counter sufficient to store an integer. The unique customer identifier 450 may comprise a unique alphanumeric identifier assigned to a user of the contactless card, and the identifier may distinguish the user of the contactless card from other contactless card users. In some examples, the customer identifier 450 may identify both a customer and an account assigned to that customer and may further identify the contactless card associated with the customer's account.

The processor 430 and memory 435 elements of the foregoing exemplary embodiments are described with reference to the contact pad 420, but the present disclosure is not limited thereto. It is understood that these elements may be implemented outside of the contact pad 420 or entirely separate from it, or as further elements in addition to the processor 430 and the memory 435 elements located within the contact pad 420.

In some examples, the contactless card may comprise one or more antennas 455. The one or more antennas 455 may be placed within the contactless card and around the processing circuitry 425 of the contact pad 420. For example, the one or more antennas 455 may be integral with the processing circuitry 425 and the one or more antennas 455 may be used with an external booster coil. As another example, the one or more antennas 455 may be external to the contact pad 420 and the processing circuitry 425.

In an embodiment, the coil of contactless card may act as the secondary of an air core transformer. A terminal may communicate with the contactless card by cutting power or amplitude modulation. The contactless card may infer the data transmitted from the terminal using the gaps in the contactless card's power connection, which may be functionally maintained through one or more capacitors. The contactless card may communicate back by switching a load on the contactless card's coil or load modulation. Load modulation may be detected in the terminal's coil through interference.

As explained above, the contactless card may be built on a software platform operable on smart cards or other devices having limited memory, such as JavaCard, and one or more or more applications or applets (applet 440) may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag. In addition, applets may be configured to perform the functions and processes described herein.

The contactless card may be configured for communication with a user device via a communication interface configured for establishing communication with the user device. The communication interface may be configured for contact-based communication, in which case the interface may have electrical circuitry and contact pads on the surface of the contactless card for establishing direct electrical communication between the contactless card and the user device. Alternatively or in addition, the communication interface may be configured for contactless communication with the user device. In such embodiments, the communication interface may be or include an NFC communication interface configured for communication with other NFC communication devices when the contactless card is within a predetermined NFC range. In some examples, the contactless card may include a second communication interface configured for establishing short range communication with the user device via Bluetooth, or other short range communication methodology. In such embodiments, the contactless card may have a short range communication antenna that is included in or connected to the short range communication interface. The contactless card may also include a power management system for use in managing the distribution of power during an NFC transaction.

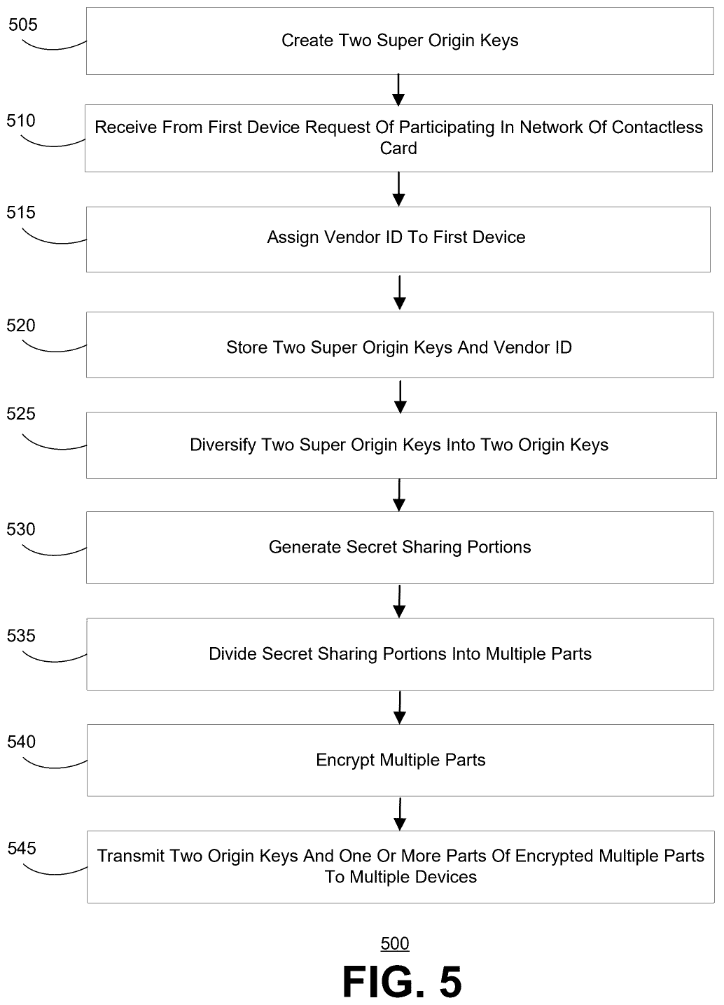

FIG. 5 illustrates a flow chart of an example method 500 for managing origin keys for cryptographic authentication of a contactless card according to an example embodiment. FIG. 5 may reference the same or similar components as those illustrated in FIGS. 1-4. The method 500 can be implemented in the system 100 and may include, but is not limited to, the following steps.

In step 505, the server 110 may create two super origin keys. For example, one super origin key can be an encryption super origin key and the other super origin key can be an authentication super origin key.

When, in step 510, the server 110 receives from the first device 120 a request of participating in a network of using a contactless card, in step 515, the server 110 can generate and assign a vendor ID for an entity associated with the first device 120. For example, the entity may be an financial institute different from an entity associated with the server 110. The entity associated with the server 110 may be an entity managing the network of using contactless cards.

In step 520, the server 110 may store the two super origin keys and the vendor ID onto the database 140. The server 110 may also store the two super origin keys and the vendor ID in one of its memories for quick searching. In some embodiment, the two super origin keys and the vendor ID can be loaded into a hardware security module (HSM). The HSM can then perform the diversification and export of the origin key/key parts.

In step 525, the server 110 may diversify the two super origin keys into two origin keys, e.g., can be an encryption origin key and can be an authentication origin key. The server 110 may diversify the two super origin keys into the two corresponding origin keys, based on the vendor ID of the first device 120, so the two corresponding origin keys can be associated with the entity of the first device 120. In cases where the two origin keys are lost, damaged, and/or otherwise needed to be recreated, the two origin keys can be regenerated specifically for the entity of the first device 120 by using the two super origin keys and the vendor ID.

In step 530, the server 110 may generate a plurality of secret sharing portions of the two origin keys. For example, the server may generate a plurality of Shannon secret sharing portions of the two origin keys. The plurality of secret sharing portions can be generated by applying an algorithm to the two origin keys.

In step 535, the server 110 may divide the plurality of secret sharing portions into multiple parts. In step 540, the server 110 may encrypt the multiple parts.

In steps 545, the server 110 may transmit the two origin keys and one or more of the encrypted multiple parts to multiple devices, such as the first device 120 and the second device 130, respectively. In some examples, of the total number of encrypted multiple parts (referred to in examples herein as “N total parts”), the server 110 may transmit a certain number (referred to in examples herein as “X parts”) of the encrypted multiple parts and the two origin keys to the first device 120, and the server 110 may transmit another certain number (referred to in examples herein as “Y parts”) of the encrypted multiple parts and the two origin keys to the second device 130, where the number of the encrypted multiple parts transmitted to the first device 120 (e.g., X parts) plus the number of the encrypted multiple parts transmitted to the second device 130 (e.g., Y parts) is less than or equal to the total encrypted multiple parts (e.g., the N total parts).

As described herein, the entity of the first device 120 may be a bank that issues a contactless card managed by the entity associated with the server 110, and the entity associated with the second device 130 may be validator or verifier of the contactless card. The entity of the first device 120 may contract the entity associated with the second device 130 for validating the contactless card. The first device 120 may customize the contactless card by diversifying the two origin keys into two unique derived keys (UDKs). For example, one of the UDKs can be an encryption key and the other one can be an authentication key. The two UDKs would be stored in the contactless card for personalization which is unique to that contactless card. When a transaction such as a purchase is conducted using the contactless card, the two UDKs stored on the contactless card would be used by the contactless card to generate two session keys (one for encryption and the other for authentication) for creating a cryptogram for validating and/or authorizing the transaction by the second device 130.

The second device 130 may be able to access the two origin keys only when the second device 130 has the necessary number of encrypted multiple parts of the plurality of secret sharing portions (e.g., the X parts plus the Y parts). That is, even though the second device 130 has received from the server 110 the Y parts of the encrypted multiple parts and the two origin keys, the second device 130 cannot access the two origin keys by having only the Y parts of the encrypted multiple parts. The second device 130 may request the additional X parts of the encrypted multiple parts from the first device 120 and then can be allowed to access the two origin keys.

The contactless card may be issued to a user by, e.g., a financial institution for identity verification for a bank account of the user, such as by the entity associated with the first device 120 and may be validated by the entity associated with the second device 130. In some examples, the contactless card may be manufactured by a third entity different from both the entity associated with the first device 120 and the entity associated with the second device 130. In such embodiments, the two origin keys and one or more parts (e.g., the Z parts) of the encrypted multiple parts of the plurality of sharing secret portions can also be transmitted by the server 110 to the third entity through a device associated with the third entity. As for the second device 130, the third entity's device may be able to access the two origin keys only when the third entity's device has all requisite parts of the encrypted multiple parts (e.g., the X parts plus the Y parts plus the Z parts) of the plurality of secret sharing portions. That is, even though the third entity's device has received from the server 110 a certain number of parts (e.g., the Z parts) of the encrypted multiple parts and the two origin keys, the third entity's device cannot access the two origin keys by having less than the requisite number of parts of the encrypted multiple parts (e.g., only the Z parts). The third entity's device may request the additional parts of the encrypted multiple parts from the first device 120 (e.g., the X parts) and the additional parts of the encrypted multiple parts from the second device 130 (e.g., the Y parts) and then can be allowed to access the two origin keys.

In some examples, the server 110 may retain one or more parts of the encrypted multiple parts of the sharing secret portions. When the two origin keys for a specific vendor are needed to recreate, the server 110 can recreate the two origin keys using the two super origin keys and the vendor ID of that specific vendor only when the server 110 receives a certain number of the multiple encrypted parts (e.g., at least one of the X, Y, or Z parts from the first device, the second device and the third device respectively), in addition to the one or more parts retained by the server 110. This can further increase the system security for the two origin keys.

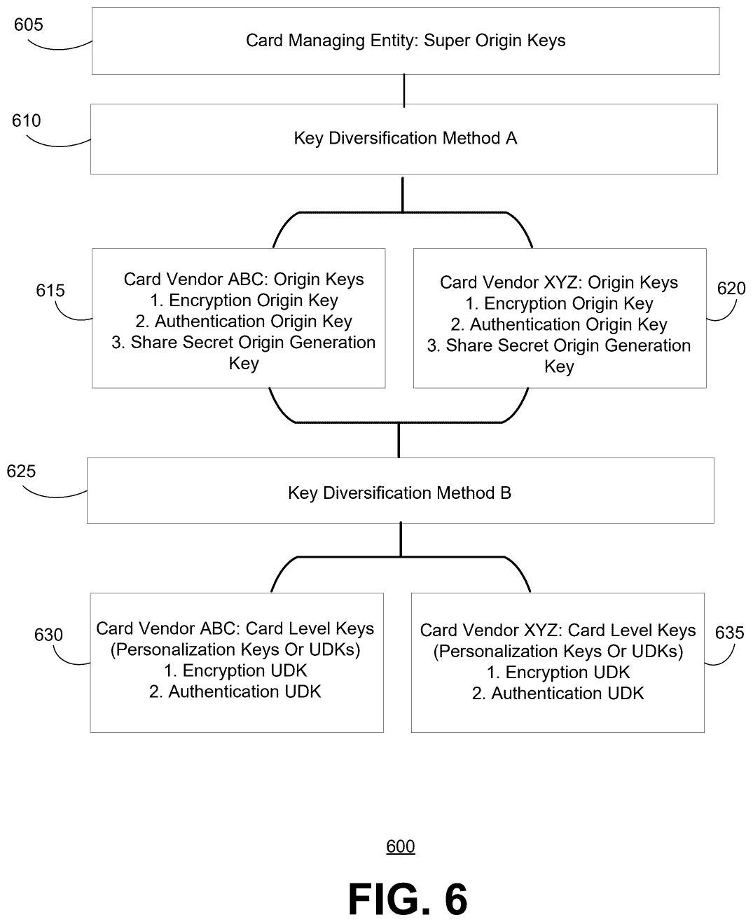

FIG. 6 illustrates a flow diagram of diversifying keys using different derivation algorithms according to an example embodiment. FIG. 6 may reference the same or similar components as those illustrated in FIGS. 1-5.

In block 605, a contactless card management entity creates two super origin keys. The contactless card management entity can be an entity associated with the server 110.

In block 610, the two super origin keys are diversified using a key diversification method A, which can be an asymmetric encryption algorithm, such as a triple Data Encryption Standard (DES) algorithm, or a symmetric encryption algorithm, such as an Advanced Encryption Standard (AES) algorithm.

In block 615, the two super origin keys are diversified using the key diversification method A and a vendor ID into three origin keys associated with a card issuer or vendor ABC (e.g., the entity associated with the second device 130). That vendor ID can be uniquely associated with the card issuer or vendor ABC. The three origin keys can include an encryption origin key, an authentication origin key, and a share secret origin generation key. The share secret origin generation key can be used to generate a plurality of sharing secret portions that can be divided into multiple parts. As described above, the multiple parts can encrypted and transmitted to different entities participating in a contactless network of the card issuer or vendor ABC.

Similarly, in block 620, the two super origin keys are diversified using the key diversification method A and a vendor ID into three origin keys associated with a card issuer or vendor XYZ (e.g., the entity associated with the second device 130). That vendor ID can be uniquely associated with the card issuer or vendor XYZ. The three origin keys can include an encryption origin key, an authentication origin key, and a share secret origin generation key. The share secret origin generation key can be used to generate a plurality of sharing secret portions that can be divided into multiple parts. As described above, the multiple parts can encrypted and transmitted to different entities participating in a contactless network of the card issuer or vendor XYZ.

In block 625, the two origin keys associated with the card issuer or vendors ABC and XYZ are diversified using a key diversification method B, which can be an asymmetric encryption algorithm, such as a triple Data Encryption Standard (DES) algorithm, or a symmetric encryption algorithm, such as an Advanced Encryption Standard (AES) algorithm. Herein, the key diversification method B can be different from the key diversification method A. For example, if the key diversification method A uses an asymmetric encryption algorithm, such as a triple Data Encryption Standard (DES) algorithm, then the key diversification method B uses a symmetric encryption algorithm, such as an Advanced Encryption Standard (AES) algorithm.

In block 630, the two origin keys (encryption origin key and authentication origin key) of the card issuer or vendor ABC are diversified using the key diversification method B into two card level keys (i.e., UDKs). The two UDKs can include an encryption UDK and an authentication UDK. The two UDKs are uniquely associated with that contactless card issued by the card issuer or vendor ABC and stored into that contactless card for personalization.

Similarly, in block 635, the two origin keys (encryption origin key and authentication origin key) of the card issuer or vendor XYZ are diversified using the key diversification method B into two card level keys (i.e., UDKs). The two UDKs can include an encryption UDK and an authentication UDK. The two UDKs are uniquely associated with that contactless card issued by the card issuer or vendor XYZ and stored into that contactless card for personalization.

In some aspects, the techniques described herein relate to a method for managing origin keys for cryptographic authentication, including: creating, by a server, at least one super origin key; diversifying, by the server, the at least one super origin key into at least one origin key; generating, by the server, a plurality of secret sharing portions of the at least one origin key; dividing, by the server, the plurality of secret sharing portions into multiple parts; encrypting, by the server, the multiple parts of the plurality of secret sharing portions; and transmitting, by the server, the encrypted multiple parts of the plurality of Shannon secret sharing portions to multiple entities.

In some aspects, the techniques described herein relate to a method, wherein the at least one super origin key includes an encryption super origin key.

In some aspects, the techniques described herein relate to a method, wherein the at least one super origin key includes an authentication super origin key.

In some aspects, the techniques described herein relate to a method, wherein the at least one origin key includes an encryption origin key or an authentication origin key.

In some aspects, the techniques described herein relate to a method, wherein the at least one origin key includes an authentication origin key.

In some aspects, the techniques described herein relate to a method, wherein the diversifying, by the server, the at least one super origin key into at least one origin key is performed using an asymmetric encryption algorithm.

In some aspects, the techniques described herein relate to a method, wherein the asymmetric encryption algorithm is a triple Data Encryption Standard (DES) algorithm.

In some aspects, the techniques described herein relate to a method, wherein the diversifying, by the server, the at least one super origin key into at least one origin key is performed using a symmetric encryption algorithm.

In some aspects, the techniques described herein relate to a method, wherein the symmetric encryption algorithm is an Advanced Encryption Standard (AES) algorithm.

In some aspects, the techniques described herein relate to a method, further including assigning, by the server, an identification (ID) number to one of the multiple entities.

In some aspects, the techniques described herein relate to a method, wherein the diversifying, by the server, the at least one super origin key into at least one origin key is performed based on the ID number of the one of the multiple entities.

In some aspects, the techniques described herein relate to a method, wherein the generating, by the server, a plurality of secret sharing portions of the at least one origin key, is performed using a secret sharing algorithm.

In some aspects, the techniques described herein relate to a method, wherein the transmitting, by the server, the encrypted multiple parts of the plurality of Shannon secret sharing portions to multiple entities, includes transmitting, by the server, one encrypted part to one of the multiple entities.

In some aspects, the techniques described herein relate to a method, wherein the transmitting, by the server, the encrypted multiple parts of the plurality of Shannon secret sharing portions to multiple entities, includes transmitting, by the server, more than one encrypted part to one of the multiple entities.

In some aspects, the techniques described herein relate to a method, wherein the transmitting, by the server, the encrypted multiple parts of the plurality of secret sharing portions to multiple entities, is performed through multiple secure channels.

In some aspects, the techniques described herein relate to a method, further including diversifying, by the server, the at least one super origin key into a secret share key.

In some aspects, the techniques described herein relate to a method, wherein the generating, by the server, a plurality of secret sharing portions of the at least one origin key, is performed based on the secret share key.

In some aspects, the techniques described herein relate to a method, wherein the at least one super origin key is created by the server in a hardware security module (HSM).

In some aspects, the techniques described herein relate to a system for managing origin keys for cryptographic authentication, including a server, the server configured to: create at least one super origin key; diversify the at least one super origin key into at least one origin key; generate a plurality of secret sharing portions of the at least one origin key; divide the plurality of secret sharing portions into multiple parts; encrypt the multiple parts of the plurality of secret sharing portions; and transmit the encrypted multiple parts of the plurality of secret sharing portions to multiple entities.

In some aspects, the techniques described herein relate to a non-transitory, computer-readable medium including instructions for managing origin keys for cryptographic authentication that, when executed on a computer arrangement, perform actions including: creating at least one super origin key; diversifying the at least one super origin key into at least one origin key; generating a plurality of secret sharing portions of the at least one origin key; dividing the plurality of secret sharing portions into multiple parts; encrypting the multiple parts of the plurality of secret sharing portions; and transmitting the encrypted multiple parts of the plurality of secret sharing portions to multiple entities.

As used herein, the term “bank” is not limited to a particular bank or type of bank. Rather, it is understood that the present disclosure includes any type of bank or other business involved in activities where products or services are sold or otherwise provided.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for managing origin keys for cryptographic authentication, comprising:
creating, by a server, at least one super origin key;
diversifying, by the server, the at least one super origin key into at least one origin key;
generating, by the server, a plurality of secret sharing portions of the at least one origin key;
dividing, by the server, the plurality of secret sharing portions into multiple parts;
encrypting, by the server, the multiple parts of the plurality of secret sharing portions; and
transmitting, by the server, the encrypted multiple parts of the plurality of secret sharing portions to multiple entities.

2. The method of claim 1, wherein the at least one super origin key comprises an encryption super origin key.

3. The method of claim 1, wherein the at least one super origin key comprises an authentication super origin key.

4. The method of claim 1, wherein the at least one origin key comprises an encryption origin key or an authentication origin key.

5. The method of claim 1, wherein the at least one origin key comprises an authentication origin key.

6. The method of claim 1, wherein the diversifying, by the server, the at least one super origin key into at least one origin key is performed using an asymmetric encryption algorithm.

7. The method of claim 6, wherein the asymmetric encryption algorithm is a triple Data Encryption Standard (DES) algorithm.

8. A system for managing origin keys for cryptographic authentication, comprising a server, the server configured to:
create at least one super origin key;
diversify the at least one super origin key into at least one origin key;
generate a plurality of secret sharing portions of the at least one origin key;
divide the plurality of secret sharing portions into multiple parts;
encrypt the multiple parts of the plurality of secret sharing portions; and
transmit the encrypted multiple parts of the plurality of secret sharing portions to multiple entities.

9. The system of claim 8, wherein the diversifying the at least one super origin key into at least one origin key is performed using a symmetric encryption algorithm.

10. The system of claim 9, wherein the symmetric encryption algorithm is an Advanced Encryption Standard (AES) algorithm.

11. The system of claim 8, wherein the server is further configured to assign an identification (ID) number to one of the multiple entities.

12. The system of claim 11, wherein the diversifying the at least one super origin key into at least one origin key is performed based on the ID number of the one of the multiple entities.

13. The system of claim 8, wherein the generating a plurality of secret sharing portions of the at least one origin key, is performed using a secret sharing algorithm.

14. The system of claim 8, wherein the transmitting the encrypted multiple parts of the plurality of secret sharing portions to multiple entities, comprises transmitting one encrypted part to one of the multiple entities.

15. The system of claim 8, wherein the transmitting the encrypted multiple parts of the plurality of secret sharing portions to multiple entities, comprises transmitting more than one encrypted part to one of the multiple entities.

16. A non-transitory, computer-readable medium comprising instructions for managing origin keys for cryptographic authentication that, when executed on a computer arrangement, cause the computer arrangement to perform actions comprising:
creating at least one super origin key;
diversifying the at least one super origin key into at least one origin key;
generating a plurality of secret sharing portions of the at least one origin key;
dividing the plurality of secret sharing portions into multiple parts;
encrypting the multiple parts of the plurality of secret sharing portions; and
transmitting the encrypted multiple parts of the plurality of secret sharing portions to multiple entities.

17. The non-transitory, computer-readable medium of claim 16, wherein transmitting the encrypted multiple parts of the plurality of secret sharing portions to multiple entities is performed through multiple secure channels.

18. The non-transitory, computer-readable medium of claim 16, wherein the actions further comprise diversifying the at least one super origin key into a secret share key.

19. The non-transitory, computer-readable medium of claim 18, wherein generating a plurality of secret sharing portions of the at least one origin key is performed based on the secret share key.

20. The non-transitory, computer-readable medium of claim 16, wherein the at least one super origin key is created in a hardware security module (HSM).
